(19) United States
(12) Patent Application Publication
(10) Pub. No.: US 2015/0097058 A1
(43) Pub. Date: Apr. 9, 2015

(54) PESTICIDE DISPENSING APPARATUS

(71) Applicants: James Vernon Stine, Tucson, AZ (US); Paul Thomas Wick, Longmont, CO (US)

(72) Inventors: James Vernon Stine, Tucson, AZ (US); Paul Thomas Wick, Longmont, CO (US)

(21) Appl. No.: 14/509,244

(22) Filed: Oct. 8, 2014

Related U.S. Application Data
(60) Provisional application No. 61/888,306, filed on Oct. 8, 2013.

(51) Int. Cl. A01M 7/00; B05B 7/04

(52) U.S. Cl. CPC A01M 7/0017; B05B 7/0416
USPC 239/373

(57) ABSTRACT

A pesticide dispensing apparatus including a canister for containing a quantity of fluid pesticide and pressurized air. The apparatus includes a spray dispenser in fluid communication with the interior cavity of the canister. The spray dispenser includes a wand coupled to a hose. The apparatus includes a pressure cap selectably air-tight sealable over the canister. The pressure cap includes a body and a pressure release valve extending bottom-to-top through the body. The pressure cap includes a pressurized air inlet valve extending top-to-bottom through the body.

### CROSS-REFERENCE TO RELATED APPLICATIONS

This invention claims priority, under 35 U.S.C. §120, to the U.S. Provisional Patent Application No. 61/888,306 to James Vernon Stine filed on Oct. 8, 2013, which is incorporated by reference herein in its entirety.

### BACKGROUND OF THE INVENTION

1. Field of the Invention

The present invention relates to compression canisters, specifically to a pesticide dispensing apparatus.

2. Description of the Related Art

Pesticide application refers to the practical way in which pesticides, (including herbicides, fungicides, insecticides, or nematode control agents) are delivered to their biological targets (e.g. pest organism, crop or other plant). Public concern about the use of pesticides has highlighted the need to make this process as efficient as possible, in order to minimize their release into the environment and human exposure (including operators, bystanders and consumers of produce). The practice of pest management by the rational application of pesticides is supremely multi-disciplinary, combining many aspects of biology and chemistry with: agronomy, engineering, meteorology, socio-economics and public health, together with newer disciplines such as biotechnology and information science.

One of the more common forms of pesticide application, especially in conventional agriculture, is the use of mechanical sprayers. Hydraulic sprayers generally include a tank, a pump, a lance (for single nozzles) or boom, and a nozzle (or multiple nozzles). Sprayers convert a pesticide formulation, often containing a mixture of water (or another liquid chemical carrier, such as fertilizer) and chemical, into droplets, which can be large rain-type drops or tiny almost-invisible particles. This conversion is accomplished by forcing the spray mixture through a spray nozzle under pressure. The size of droplets can be altered through the use of different nozzle sizes, or by altering the pressure under which it is forced, or a combination of both. Large droplets have the advantage of being less susceptible to spray drift, but require more water per unit of land covered. Due to static electricity, small droplets are able to maximize contact with a target organism, but very still wind conditions are required.

Some improvements have been made in the field. Examples of references related to the present invention are described below in their own words, and the supporting teachings of each reference are incorporated by reference herein:

U.S. Pat. No. 8,282,023, issued to Olander et al., discloses fluid storage and dispensing systems, and processes for supplying fluids for use thereof. Various arrangements of fluid storage and dispensing systems are described, involving permutations of the physical sorbent-containing fluid storage and dispensing vessels and internal regulator-equipped fluid storage and dispensing vessels. The systems and processes are applicable to a wide variety of end-use applications, including storage and dispensing of hazardous fluids with enhanced safety. In a specific end-use application, reagent gas is dispensed to a semiconductor manufacturing facility from a large-scale, fixedly positioned fluid storage and dispensing vessel containing physical sorbent holding gas at subatmospheric pressure, with such vessel being refillable from a safe gas source of refill gas, as disclosed herein.

U.S. Pat. No. 8,056,774, issued to Arcuri et al., discloses a fluid dispensing system includes a container, a pump assembly and a bleed valve. The pump assembly is connected to the container selectively pressurizing the container and includes an outlet port. The outlet port has a check valve precluding flow from the container through the outlet port. The bleed valve is in communication with an aperture formed through the container. The bleed valve relieves excess pressure in the container.

U.S. Pat. No. 5,174,343, issued to Rood, discloses an improved pesticide application utilizes a relatively large replenishment tank to store several working days requirements of pesticide solution at a relatively high pressure head. Both solution and pressure head, portions thereof, are transferred to a portable, working cylinder from the replenishment tank. Because a pressure head is directly transferred from the replenishment tank to the portable cylinder, rather than creating a pressure head within the cylinder solely by the transfer of solution under pressure to the cylinder, the pressure head within the portable cylinder is maintained for a significant working period. The improved pesticide application system requires the handling of concentrated pesticides and water only once every several days, rather than 3 or 4 times a day. No manual hand pumping is required to maintain a pressure head within the portable cylinder.

U.S. Patent Application Publication No.: 2011/0042108, by Hiebert, discloses a portable compressed gas foam system having a rocket engine, fueled with hydrogen peroxide and a suitable propellant, which produces exhaust gases. The exhaust gases are injected into a water tank, aerating the water and pressurizing the water tank. Foam concentrate may be added to the tank or separately in a mixing stage and is aerated by the aerated and pressurized water. The aeration produces bubbles in the foam and entrains exhaust gas within the bubbles. The aerated foam can then be sprayed onto a fire through a foam injection nozzle, extinguishing the fire both by wetting the burning materials and by smothering it by reducing the amount of oxygen available to burn. The invention may also be adapted for use in a fire hose or in an underslung bucket.

The inventions heretofore known suffer from a number of disadvantages which include being expensive, not being economical, having too many parts, not being durable, causing strain for operators, being difficult to use, taking a long time to charge the canister, being heavy, having a high total canister weight, being dangerous, leaking, having too many moving parts, being dangerous during the charging process, exposing operators to chemicals, reducing the possible volume of work that can be performed in a day by a technician, and/or increasing related costs (workman's compensation, and/or etc.).

What is needed is a pesticide dispensing apparatus that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available pesticide dispensing apparatuses. Accordingly, the present invention has been developed to provide a pesticide dispensing apparatus and a pressure cap that is easily integrated into currently available pressure canisters.

According to one embodiment of the invention, there is a pesticide dispensing apparatus that may include a canister that may be for containing a quantity of fluid pesticide and pressurized air. The canister may include an interior cavity that may be accessible through a top aperture. The apparatus may include a spray dispenser that may be in fluid communication with the interior cavity of the canister. The spray dispenser may include a wand that may be coupled to a hose. The apparatus may include a pressure cap that may be selectably air-tight sealable over the top aperture of the canister. The pressure cap may include a body and a pressure release valve that may be extending bottom-to-top through the body. The pressure cap may include a pressurized air inlet valve that may be extending bottom-to-top through the body; wherein the pressurized inlet may not orthogonal to the body. The body of the pressure cap may not include any raised collars. The pressure cap may not include a manual pump. The pressure cap may include a no-profile fixed position handle. The pressurized air inlet valve may include a mounting structure that may be selectably coupled to a nozzle of a pressurized dispenser. A housing of each of the pressure release valve and the pressurized air inlet valve of the pressure cap and the handle may be integral to the body and may be formed as a single unit together with the body.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a perspective view of a prior art pressure canister, according to one embodiment of the invention;

FIG. 2 is a perspective view of a prior art pressure canister, according to one embodiment of the invention;

FIG. 3 is a perspective view of a pesticide dispensing system in a charging mode, according to one embodiment of the invention;

FIG. 4 is a partial perspective view of a pesticide dispensing apparatus, according to one embodiment of the invention;

FIG. 5 is a partial perspective view of a pesticide dispensing apparatus, according to one embodiment of the invention;

FIG. 6 is a cross-sectional view of a pressure release valve of a pressure cap, according to one embodiment of the invention;

FIG. 7 is a side elevational view of a pressure release valve of a pressure cap, according to one embodiment of the invention;

FIG. 8 is a side elevational view of a pressure cap, according to one embodiment of the invention; and

FIG. 9 is a top plan view of a pressure cap, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

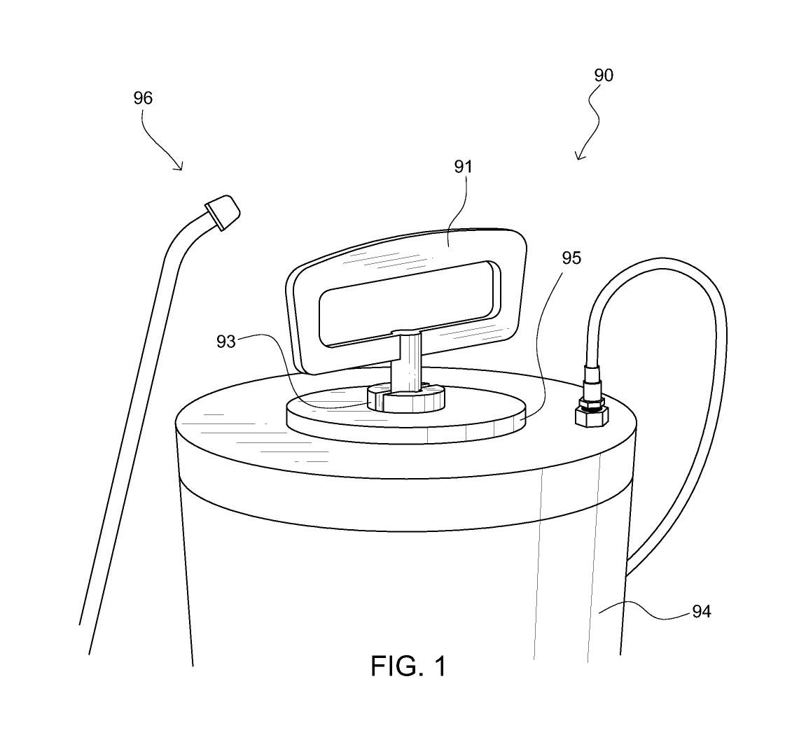

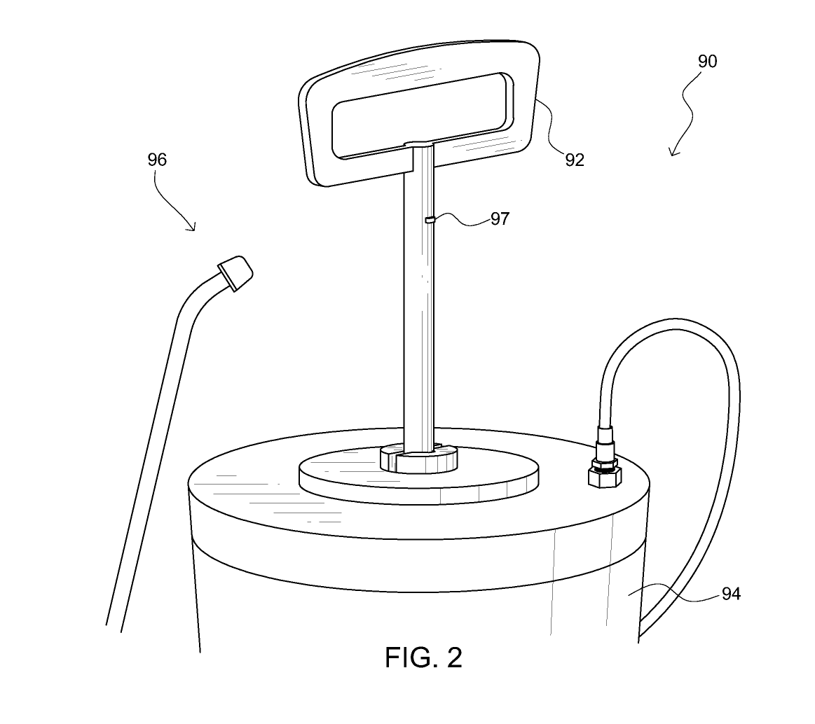

FIGS. 1 and 2 illustrate a pair of perspective views of a prior art pressure canister, according to one embodiment of the invention. There is shown a prior art compression canister 90 having a hand pump with a handle 92, a compression canister 94, and a dispensing nozzle 96.

The illustrated prior art compression canister 90 is configured to manually pump fluids from a compression canister 94. The prior art compression canister 94 includes a hand pump configured to pressurize the air within the canister, thereby providing a pressurized spray of fluid out through a dispensing nozzle 96. The hand pump is generally a structure included in a cap 91 for the canister (can) such that the handle 92 of the hand pump may be locked into place in association with raised collars 93 on the cap and then forms the handle of the can. The illustrated handle 92 of the hand pump is a high profile handle, meaning that it extends substantially above the plane of the cap.

The raised collars of the cap include vertical slots 95 through which peg(s) 97 on the pump shaft may pass. The peg(s) 97 are locked into place by twisting the handle of the pump shaft and thus trapping the pegs 97 in horizontal slots through the raised collars 93 that are accessible from within the vertical slots 95. When the operator desires to unlock the pump shaft and handle, the operator twists the handle (usually also pressing downwardly a bit) in the direction opposite that used to lock the peg(s) 97 into place until the peg(s) 97 are aligned with the vertical slot(s) 95 of the raised collar 93. The handle 92 may then be pulled upwardly, removing the peg(s) 97 from the collar 93.

The handle 92 can be thusly unlocked and then used to charge the can with pressurized air by pumping air into the can through mechanical action of the handle, much like a bicycle pump. Generally the body of the pump is disposed in an interior of the can and this keeps the mechanism from being exposed to potential harm outside the can. However, the pump mechanism takes up useful storage space inside the can. Further, the hand pump adds substantial weight to the can during operation.

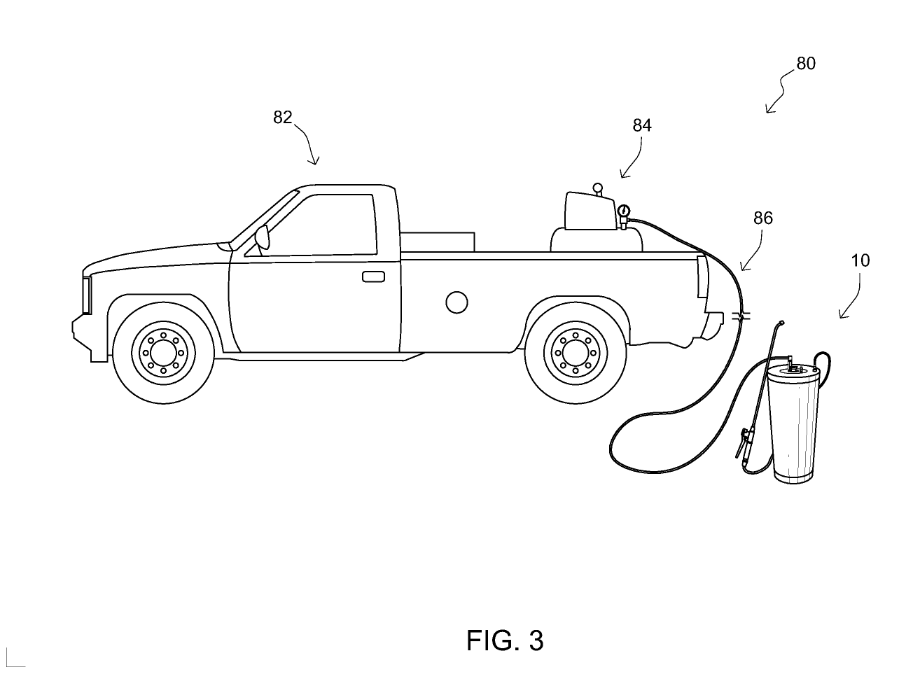

FIG. 3 is a perspective view of a pesticide dispensing system, according to one embodiment of the invention. There is shown a pesticide dispensing system 80 including a vehicle 82 having an onboard air compressor (or compressed air tank) 84 and a hose 86 coupling the air compressor to a pesticide dispensing apparatus 10. In operation an operator of the pesticide dispensing system, upon arrival at a location where pesticide is to be dispensed, removes the illustrated canister from the truck, connects the hose from the air compressor (or tank of already compressed air) to the canister and activates the distribution of compressed air to the canister. On reaching a desired compression within the canister, the operator disconnects the hose and stores the hose within the back of the vehicle. The operator may then carry the canister, without the added weight or bulk of a hand pump, to the location and dispense pesticide as desired. Should the canister need a recharge, such may be accomplished at the truck in the same manner. Should the canister need additional pesticide mixture, the cap may be removed and the contents replenished through the aperture sealed by the cap, then the canister would be recharged as previously described.

The illustrated pesticide dispensing system 80 includes an air compressor 84 disposed within a vehicle 82, such as a truck, wherein the air compressor 84 is disposed about a bed of the truck. The air compressor 84 is configured to provide pressurized air to a pesticide dispensing apparatus 10 through a hose 86. The air compressor 84 is in fluid communication with the apparatus 10 through a pressure cap. The pressure cap is configured to seal in appropriate pressure from the air compressor 84 even after disconnected therefrom. Pressurized fluid then exits out of the apparatus 10 through a dispensing nozzle when the nozzle is activated.

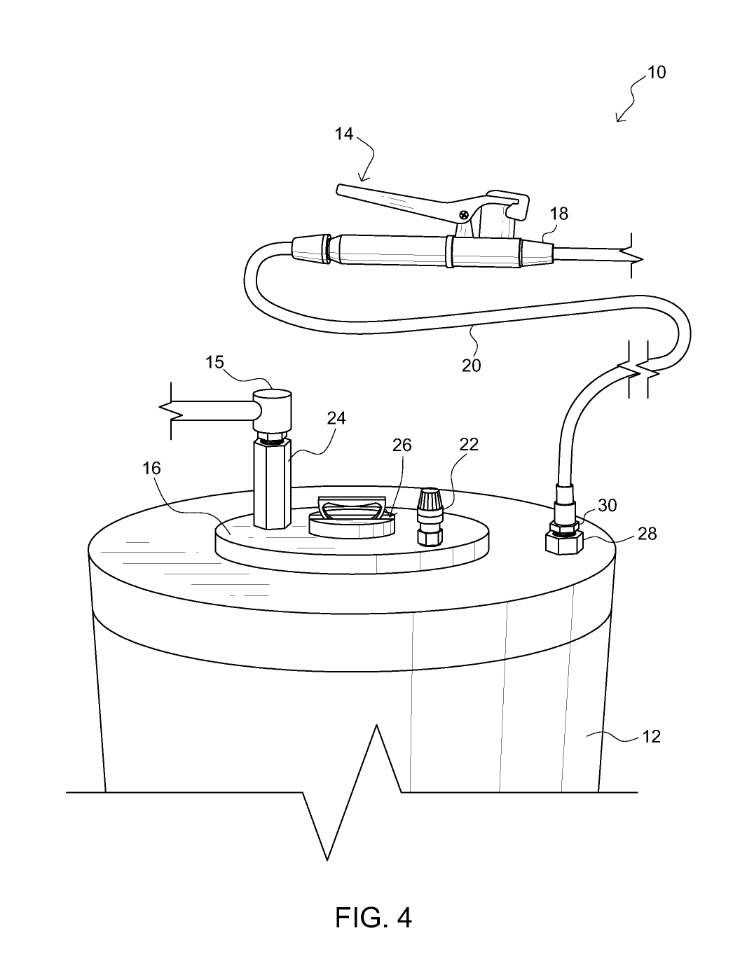

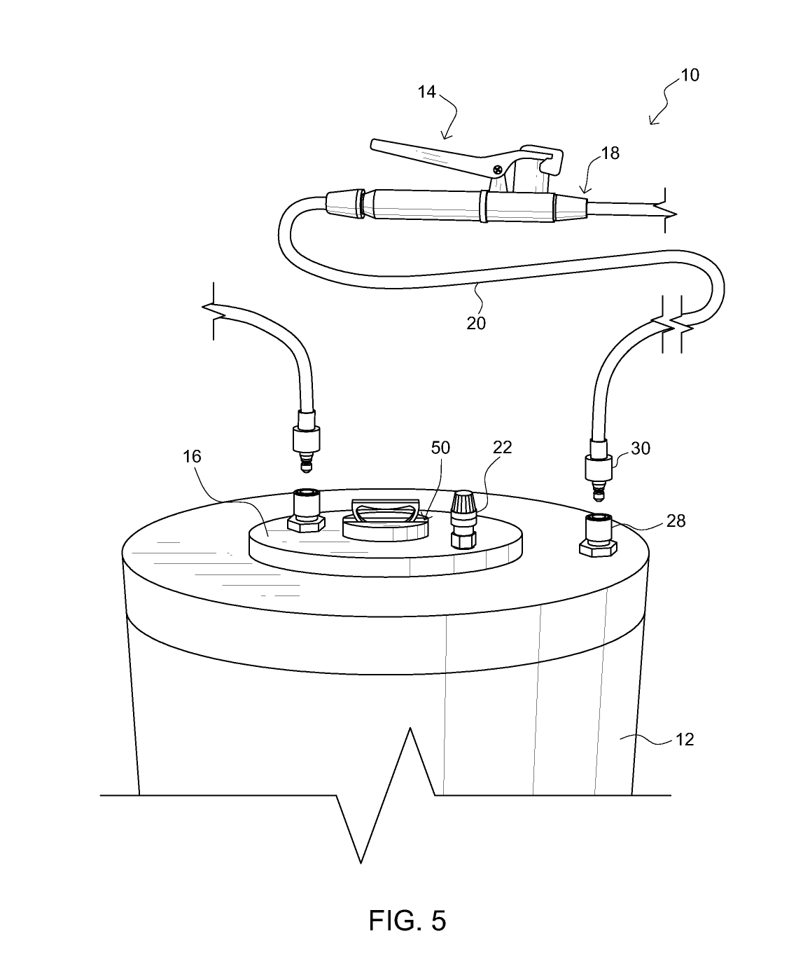

FIGS. 4 and 5 are partial perspective views of a pesticide dispensing apparatus, according to one embodiment of the invention. There is shown a pesticide dispensing apparatus 10 including a canister 12, a spray dispenser 14, and a pressure cap 16.

The illustrated pesticide dispensing apparatus 10 is configured to provide pressurized fluid spray. The pesticide dispensing apparatus 10 includes a canister 12 for containing a quantity of fluid pesticide and pressurized air. The canister 12 includes an interior cavity that is accessible through a top aperture. The apparatus 10 includes a spray dispenser 14 in fluid communication with the interior cavity of the canister 12 such that pressurized fluid from within the canister may be dispensed through the spray dispenser. The spray dispenser 14 includes a wand 18 coupled to a hose 20 through which pressurized fluid may be dispensed to desired locations.

The illustrated apparatus 10 includes a pressure cap 16 selectably air-tight sealable over the top aperture of the canister 12, generally by use of a threaded connection between the cap and the region of canister about the top aperture of the canister. The illustrated pressure cap 16 includes a disc-like body, a pressure release valve 22 extending bottom-to-top through the body (i.e. air flows from bottom-to-top and not the other way) and a pressurized air inlet valve 24 extending top-to-bottom (i.e. air flows from top-to-bottom and not the other way) through the body. The illustrated pressurized inlet valve 24 is orthogonal to the body.

The body of the illustrated pressure cap does not include any raised collars and does not include a manual pump. The pressure cap 16 includes a no-profile fixed position handle 50, meaning that the handle barely extends above the top surface of the disc-like body of the cap. This reduces the bulk of the cap and makes it easier to charge the canister.

The illustrated pressurized air inlet valve 24 includes a mounting structure (e.g. a quick-connect) selectably coupled to a nozzle 15 of a pressurized dispenser (e.g. air compressor). The illustrated hose 20 also includes a mounting structure 30 (e.g. a quick-connect style connector) for easily coupling and decoupling the hose to/from the canister at the outlet 28 thereof.

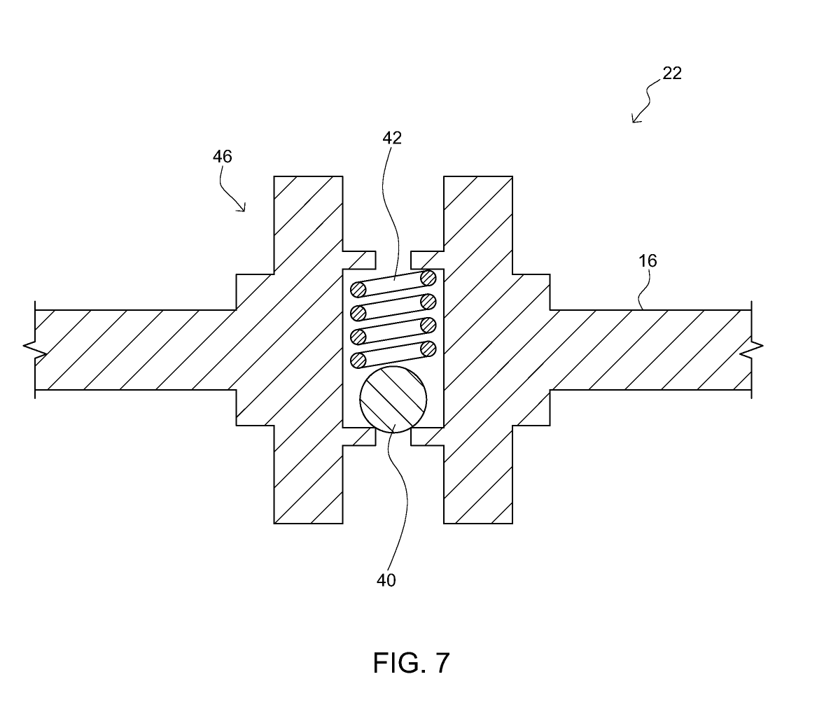

A housing of one or more of the pressure release valve 22 and the pressurized air inlet valve 24 of the pressure cap 16 and the handle may be integral to the body and may be formed as a single unit together with the body (e.g. See FIG. 7) thus reducing the risk of leaks or other problems more likely when valves/fittings comprise multiple parts.

The illustrated pesticide dispensing apparatus 10 is configured to provide a pressurized source for dispensing of pressurized fluid from a compression canister. The pesticide dispensing apparatus 10 includes a pressure cap 16 configured to couple about an aperture of a pressurized pesticide dispensing canister, generally located at a top end of the canister. The pressure cap 16 includes a pressurized air inlet valve 24 (such that when pressurized air is applied, as from an air compressor, to the pressurized air inlet valve 24, the air is allowed to traverse the inlet but air is not allowed to traverse in the opposite direction) and a pressure release valve 22 configured to allow air to traverse the cap in the direction opposite the air inlet but only if a threshold pressure is exceeded. The illustrated pressure cap 16 (replacement cap) is configured to be carved out of a single piece of aluminum instead of being comprised of multiple parts. The pressure cap 16 is configured to match up and couple to any air compressor canister, so that any air compressor canister may be used to fill the tank with air. The pressure cap 16 may be shaped and sized to fit onto and seal existing canisters and to replace existing caps that include hand pumps.

Non-limiting examples of air inlet valves may be an inlet valve as described in U.S. Patent Publication No.: 2010/0054958; or an inlet valve as described in U.S. Patent Publication No.: 2007/0006923; or an air inlet valve as described in WO 1996010721, which are incorporated herein for their supporting teachings.

Non-limiting examples of pressure release valves may be a pressure release valve as described in U.S. Pat. No. 6,189,856; or a pressure release valve as described in U.S. Pat. No. 8,256,647; or a pressure relief valve as described in U.S. Pat. No. 8,353,418, which are incorporated herein for their supporting teachings.

Non-limiting examples of air compressors may be an air compressor as described in U.S. Patent Publication No.: 2011/0158828; or an air compressor as described in WO 20050826759; or an air compressor as described in U.S. Pat. No. 1: 5,054,740, which are incorporated herein for their supporting teachings.

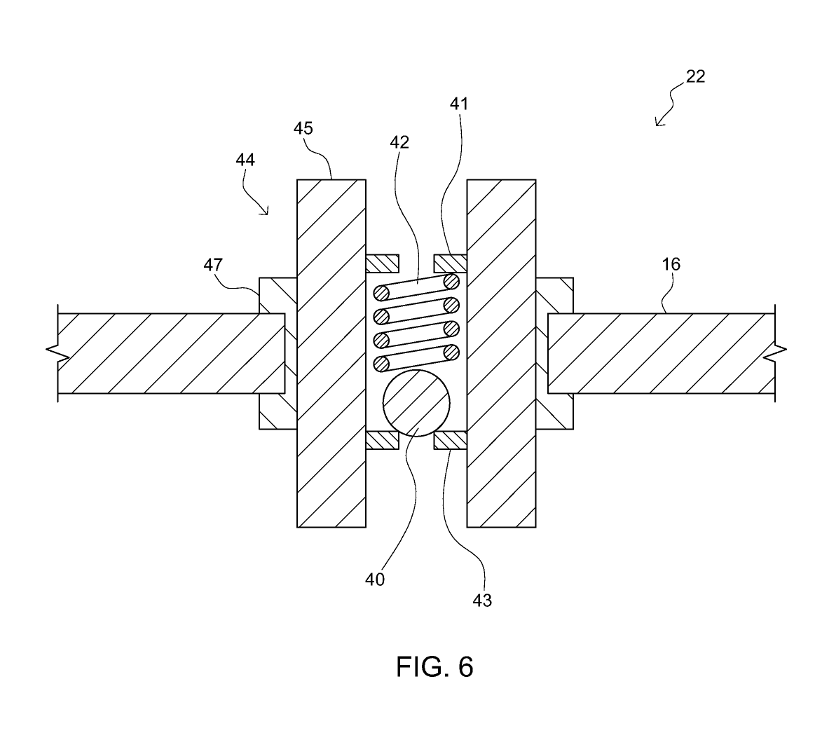

FIGS. 6 and 7 illustrate a cross-sectional view and a side elevational view of a pressure release valve of a pressure cap, according to one embodiment of the invention. There is shown a pressure release valve 22 of a pressure cap 16 including varied valve body structures 44, 46, and a simple ball-and-spring 40 and 42 valve assembly. The illustrated valves are provided to explain what is meant by a valve housing/body being integral to a cap. Specifically, the housing/body of the valve includes those non-moving support structures of the valve that cooperate with the moving/operational components of the valve and such structures may be formed as a single unit together with the cap and integral thereto. It is understood that an inlet valve may have very similar, but reversed in direction, structure.

The illustrated pressure cap 16 is configured to fit about a compression canister and configured to dispense a pressurized fluid. The pressure cap 16 is configured to couple to a compression canister. The pressure cap 16 includes a pressure release valve 22 configured to release pressurized air within the compression canister after use. The pressure cap 16 is configured to couple to a compression canister by threads, wherein the threads are configured to permit the cap to screw into a threaded aperture of the canister until the cap is seated against a gasket disposed about the seating area, thereby forming an air-tight seal between the cap and can.

The illustrated mounting structure 44 is configured to sealably couple a valve 22 to a pressure cap 16 and uses multiple parts to do so. The pressure release valve 22 includes a ball 40 and a spring 42 to release pressure within the canister after use. The mounting structure 44, as illustrated in FIG. 5, provides an air-tight seal to the canister during use. The mounting structure 44 includes retaining rings 41 and 43 that trap the ball and spring within the housing of the valve. The retaining rings 41 and 43 are fixedly coupled to the valve bore 45, which circumscribes the inner workings of the valve 22. The valve bore 45 is fixedly coupled to a rivet-like mounting ring 47 which fixedly couples the valve bore 45 to the body 16 of the pressure cap.

The illustrated mounting structure 46 operates in a similar manner to that of its counterpart 44, but does so with a single unified body that is integral to the body of the pressure cap and is formed therefrom. Thus the ball 40 and spring 42 are trapped therein and operate to provide a pressure threshold release through the cap without having the additional parts, connections and seams found in the counterpart structure 44.

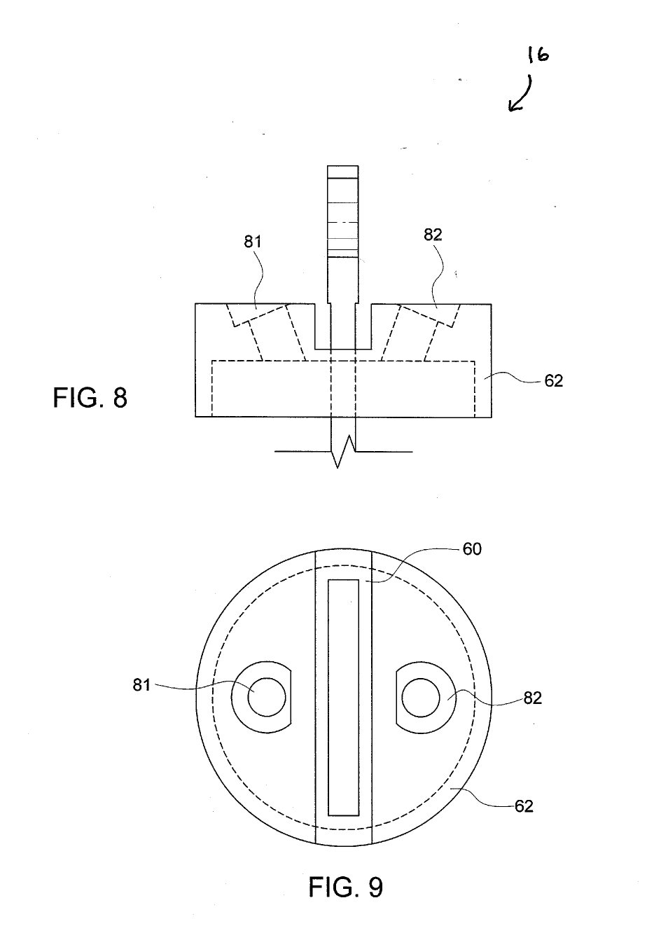

FIGS. 8 and 9 illustrate a side view and a top plan view of a pressure cap, according to one embodiment of the invention. There is shown a pressure cap 16 including angled sockets 81 and 82 for placement of a pressure release valve and a pressure inlet valve. The angled sockets for the valves enhances the speed and ease with which the operator can use the pressure cap, while also increasing the safety thereof.

The pressure cap 16 is configured to be more economical, include fewer parts, be more durable, provide less strain for operators, is easier to use, is faster charging, includes a lower total canister weight, is safer charging, is more efficient and effective, is cost effective, and/or provides a lower employee costs (workman's comp., etc.).

The pressure cap 16 may couple to the canister so that, other than the air inlet and pressure release valves, it may be flush with the same, having an inset handle. One or more of the air inlet and pressure valve may also be flush with the surface of the canister/cap. The illustrated cap 16 includes a rectangular handle 60 inset into the cap body 62.

The pressurized compression canister may include a replacement cap 16 configured to replace an existing cap that is on a one gallon compression canister for commercial/residential pesticide dispensing. Instead of an air compression pump, the replacement cap includes an air inlet and a pressure release valve so that the replacement cap may be pressurized externally without manual operation of a pump.

The illustrated pressure cap 16 includes a pressurized air inlet valve configured to be in communication with a compressor configured to provide compressed air. The compressor is configured to provide pressure to the compression canister to force a fluid through the canister and out a dispensing nozzle. The pressure cap 16 includes a pressure release valve configured to release compressed air from an interior of the compression canister.

In one non-limiting example, there is a replacement cap 16 for the existing cap that is on the standard one gallon compression can for commercial/residential pesticide dispensing. It is contemplated that containers (cans) of various sizes, shapes and capacities may be used, including but not limited to cans having a capacity of any of 2 gallons, 5 gallons, 1 liter, 1 pint, 2.5 gallons, and the like and combinations thereof. Instead of an air compression pump, it has an air inlet and a pressure release valve so that it can be pressurized externally without manual operation of a pump. It does not include a manual pump not any of the devices necessary therefore, such as but not including the pump mechanism and the pump handle. Accordingly, the replacement cap reduces the overall weight of the can and increases the available internal storage capacity thereof. It may be that the cap, including the air inlet and the release valve are carved/formed out of a single piece of material (brass, plastic, steel, aluminum, etc.) so that there are fewer parts and less of a likelihood that parts may fail or otherwise need to be replaced. The air inlet of the replacement cap may include a mating structure configured to mate with any air compressor such that any air compressor may be utilized in charging a can with the replacement cap attached. The replacement cap may be provided to users of existing cans and/or provided with new cans being sold.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A pesticide dispensing apparatus, comprising:
a) a canister for containing a quantity of fluid pesticide and pressurized air, including an interior cavity accessible through a top aperture;
b) a spray dispenser in fluid communication with the interior cavity of the canister, including a wand coupled to a hose; and
c) a pressure cap selectably air-tight sealable over the top aperture of the canister and including a body, a pressure release valve extending bottom-to-top through the body, and a pressurized air inlet valve extending top-to-bottom through the body.

2. The apparatus of claim 1, wherein the pressurized inlet is not orthogonal to the body.

3. The apparatus of claim 1, wherein the body of the pressure cap does not include any raised collars.

4. The apparatus of claim 1, wherein the pressure cap does not include a manual pump.

5. The apparatus of claim 1, wherein the pressure cap includes a no-profile fixed position handle.

6. The apparatus of claim 1, wherein the pressurized air inlet valve includes a mounting structure that selectably couples to a nozzle of a pressurized dispenser.

7. The apparatus of claim 1, wherein a housing of each of the pressure release valve and the pressurized air inlet valve of the pressure cap and the handle are integral to the body and formed as a single unit together with the body.

8. A pressure cap configured to selectably couple to a pesticide dispensing canister, selectably air-tight sealable over a top aperture of a canister and including a body, a pressure release valve extending bottom-to-top through the body, and a pressurized air inlet valve extending top-to-bottom through the body.

9. The apparatus of claim 8, wherein the pressurized inlet is not orthogonal to the body.

10. The apparatus of claim 9, wherein the body of the pressure cap does not include any raised collars.

11. The apparatus of claim 10, wherein the pressure cap does not include a manual pump.

12. The apparatus of claim 11, wherein the pressure cap includes a no-profile fixed position handle.

13. The apparatus of claim 12, wherein the pressurized air inlet valve includes a mounting structure that selectably couples to a nozzle of a pressurized dispenser.

14. The apparatus of claim 13, wherein a housing of each of the pressure release valve and the pressurized air inlet valve of the pressure cap and the handle are integral to the body and formed as a single unit together with the body.

15. A pesticide dispensing apparatus, comprising:
a) a canister for containing a quantity of fluid pesticide and pressurized air, including an interior cavity accessible through a top aperture;
b) a spray dispenser in fluid communication with the interior cavity of the canister, including a wand coupled to a hose; and
c) a pressure cap selectably air-tight sealable over the top aperture of the canister and including a body, a pressure release valve extending bottom-to-top through the body, and a pressurized air inlet valve extending top-to-bottom through the body; wherein the pressurized inlet is not orthogonal to the body; wherein the body of the pressure cap does not include any raised collars; wherein the pressure cap does not include a manual pump; wherein the pressure cap includes a no-profile fixed position handle; wherein the pressurized air inlet valve includes a mounting structure that selectably couples to a nozzle of a pressurized dispenser; wherein a housing of each of the pressure release valve and the pressurized air inlet valve of the pressure cap and the handle are integral to the body and formed as a single unit together with the body.
